(19) United States
(12) Patent Application Publication
(10) Pub. No.: US 2019/0066075 A1
(43) Pub. Date: Feb. 28, 2019

(54) SYSTEM AND METHOD FOR PROVIDING POINT OF SALE CLOUD SERVICES

(71) Applicant: Walmart Apollo, LLC, Bentonville, AR (US)

(72) Inventors: Charles Lobo, Cave Springs, AR (US); Biju Nair, Bentonville, AR (US); Sid Shake, Rogers, AR (US); Anish Devireddy, Bentonville, AR (US)

(73) Assignee: Walmart Apollo, LLC, Bentonville, AR (US)

(21) Appl. No.: 16/116,641

(22) Filed: Aug. 29, 2018

Related U.S. Application Data
(60) Provisional application No. 62/552,002, filed on Aug. 30, 2017.

(51) Int. Cl. G06Q 20/20; G06Q 30/06; H04L 29/08

(52) U.S. Cl. CPC G06Q 20/202; G06Q 20/209; H04L 67/10; G06Q 30/0633; G06Q 20/206

(57) ABSTRACT

Systems, methods, and computer-readable storage media for money services on a money services device such as a kiosk device, tablet device, mobile device, virtual reality device, mixed reality device and the like are provided. An application runs on the money services device and communicates with remote point of sale services to perform point of sale functions like configuring the money services device, monitoring peripheral devices, maintaining a transaction cart, tendering the transaction, printing a transaction receipt and recording the transaction in a transaction log (TLOG).

### BACKGROUND

### 1. Technical Field

The present disclosure relates to point of sale cloud services, and more specifically to providing checkout for money services using point of sale cloud services.

### 2. Introduction

Money services such as “Send Money,” “Pay a Bill,” or “Cash a Check” may be offered in a retail store environment. The services may be offered at a point of sale terminal, such as a check-out register, or at a non-point of sale terminal, such as a stand alone kiosk. Non-point of sale terminals typically do not have the capability to accept tender. Currently, a customer using a non-point of sale terminal for money services needs to stage the transaction, that is select the service, recipient, sender, amount, etc., on the non-point of sale device. The transaction must then be completed on a point of sale device, for example by using the tendering functionalities of the store register. The current system limits the locations where money service transactions can be completed, leading to increased transaction time, lower customer throughput and customer dissatisfaction. In addition, any changes to the money services offered require changes to be made to each point of sale terminal in order to process the money services transaction. Changes to the point of sale terminal requires corresponding changes be made to the back end systems processing the point of sale transactions, limiting the integration of new service offerings.

There is a need for a system and method that decreases the speed of integrating new services into the money services system, improve transaction time, and that allows different types of client devices be available, while maintaining the back end financial services system.

### SUMMARY

A method for performing concepts disclosed herein can include: presenting money services options to a user via an interface on a money services device; receiving a selected option via the interface and providing information regarding the selected option to a financial services provider remote from the money services device; receiving at the money services device vendor and pricing options for the selected option from the financial services provider and presenting the pricing options to the user via the interface; receiving a selected vendor and pricing option via the interface and providing information regarding the selected vendor and pricing option to the financial services provider; receiving transaction details including a fee amount for the transaction from the financial services provider and presenting the transaction details to the user; calling a remote service from the money services device to set up a cart associated with the transaction; receiving transaction details at the money services device from the remote service and providing the details to the user; receiving a tender of payment from the user at the money services device and calling the remoter service to process the tender; receiving an authorization for the transaction; calling the remote service from the money services device to print a receipt; and calling the remote service from the money services device to log the transaction.

A system according to embodiments of the invention may comprise: a money services device for a financial transaction configured to present money service options to a customer, received a selected option, and present vendors for the selected option via an interface, accept tender of payment for the transaction, and print a receipt; a point of sale service remote from the money service device and in communication with the money services device, the point of sale service including: a configuration module to configure the money services device, a peripheral module to monitor peripherals, a cart module to set up a cart for the transaction, a transaction module to process tender of payment, a print module to control printing a receipt for the transaction, and a logging module to log the transaction; and a financial service provider remote from the money services device and the point of sale service, and in communication with the money services device

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

### BRIEF DESCRIPTION OF THE DRAWINGS

FIG. 1 illustrates an exemplary system;

FIG. 2 illustrates an exemplary method; and

FIG. 3 illustrates an exemplary computer system.

### DETAILED DESCRIPTION

Systems, methods, and computer-readable storage media configured according to this disclosure provide money services on a money services device such as a kiosk device, tablet device, mobile device, virtual reality device, mixed reality device and the like. An application runs on the money services device and communicates with remote point of sale services to perform point of sale functions such as maintaining a transaction cart, tendering the transaction, printing a transaction receipt and recording the transaction in a transaction log (TLOG). Other services such as configuring the money services device and monitoring peripheral devices may also be provided.

Embodiments of the invention leverage remotely hosted point of sale services, for example services hosted on the Cloud, to deliver money services via non-point of sale devices. There are no current money services solutions which are able to accept tender on non-point of sale devices. Embodiments of the invention are able to accept tender on the money services device via a system of remote point of sale services.

Embodiments of the invention thus provide a new money services system. Point of sale services are modularized and hosted remotely from the device conducting the transaction with the customer. This allows non-point of sale devices to conduct the transaction from start to finish by utilizing the remote services. Additional types of hardware devices can now be used as money service devices in the system. In addition, new service offerings can quickly be configured and integrated into the money services system. Efficiency is improved by providing the point of sale services in a central location, allowing changes to existing services and new services to be deployed in shorter time. System processing times are also improved by consolidating the point of sale services and transactions.

According to an embodiment, an app that runs on kiosks, tablets, mobile phones, virtual reality devices or mixed reality devices may be used to initiate a money services transaction. A customer can select one of the offered services, such as “Send Money,” “Pay a Bill,” or “Cash a Check” money services on the app. When one of the options is selected the app prompts the customer to enter transaction information. This information is sent to a financial services system, which may be remote and which returns pricing data for the transaction to the app. This pricing data is displayed to the customer, who then selects a preferred option. The selected option is provided to the financial services system.

Once the option is accepted and processed by the financial services system, the final details of the transaction are sent to the app and presented to the customer. The app consumes remote point of sale services to continue the transaction. The app may call a cart module hosted on the remote point of sales service. The cart module sets up a transaction cart for the transaction. The app uses the details from the cart module to provide the transaction details like UPC, description, face amount, fee amount and tax to the customer. The customer now knows the cost for the requested service.

The customer can use the same money services device to stage the transaction and to tender payment. Payment may be cash, debit card, credit card, check or another payment method. In an example, an in-store kiosk is used to conduct the transaction. A card reader for the kiosk is provided to process a debit or credit card to pay for the transaction. The app provides the encrypted card information to a checkout module of the point of sale service to authorize the transaction. If authorization is successful the app calls receipt module at the the point of sale service to print the receipt. After receipt is printed the app sends the transaction details to the point of sale service for the transaction log module to archive and complete the transaction.

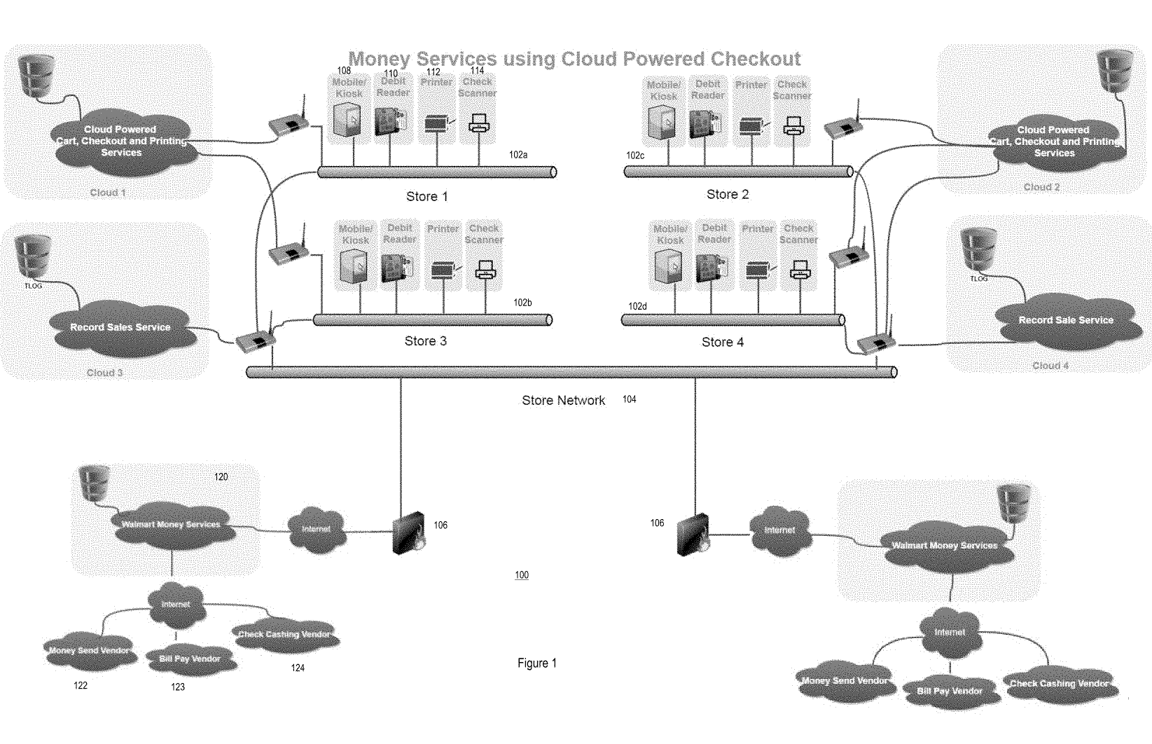

FIG. 1 illustrates an exemplary system 100 according to embodiments of the invention. The system 100 is described as being deployed in a retail store environment, but is not limited to such an environment. FIG. 1 illustrate four store systems 102a-102d, each connected to a store network 104. The store network 104 is connected to external networks, such as the internet, via firewall 106. A money services device 108 is connected to the store system 102. The money services device 108 may include a customers' mobile phones, kiosks, tablets, mobile phones, virtual reality devices and mixed reality devices and the like. The money service device 108 may differ from a traditional point of sale terminal in that the money services device 108 itself is not configured to accept or process tender of payment. A card reader 110, printer 112, and check scanner 114 may also be associated with the money services device 108, be connected to the store system 102, or be part of the money services device 108. One or more of money services device 108, card reader 110, printer 112, and check scanner 114 may be provided in each store. Also, the money services device 108 may be remote from the retail store, such as in the case of a mobile phone, or otherwise connect to the store network remotely. A money services application may run on the money services device 108. The money services application serves as the customers interface with the money services functionality. The money services device 108 is configured to present menus, options, receive inputs, etc.

Remote point of sale services may be provided. Typical point of sale functions may be modularized and made available to the app via a remote system. Here, a cloud based solution 116 is shown. The cloud based solution 116 may include a configuration module, a monitoring module, cart module, tender module, print module and log module. The modules may be separate from each other or combined in any fashion. The modules provide point of sale services to the app running on the money services device 107. One or more instances of the point of sale services may be provided. Here, four clouds 116 are shown, but other numbers are also contemplated. In implementation, hundreds or thousands of stores and money service devices may utilized the remote point of sale service. A database may also be provided. The modules may be provided as web services accessed from the application using the REST API.

The configuration module may include the software or firmware to configure the money services device 108. The configuration module may be call periodically by the app or run at specified times. The configuration module can provide any updates to the money services device 108. The updates may include changes to the menus, options, etc. that are presented on the money services device. Also, the configuration module may provide the necessary software for the money services device to offer new services.

The monitoring module may monitor the peripherals, such as the card reader 110, printer 112, scanner 114, etc. The monitoring module may determine the status of the peripherals, such as whether the printer needs papers, the card reader is on-line, etc.

The cart module can create a shopping cart for the customer. The cart module can add items to the cart, the item quantity, face amount, UPC, and the like, similar to a traditional e-commerce shopping cart.

The tender module may process the transaction. The cart module may create the purchase contract, obtain and verify credit/debit card information, add the payment and signature information, etc.

The print module attends to the printing of the receipt in connection with the printer. The log module completes and logs the transaction.

A financial service system 120 may communicate with the store network over the internet. The financial services system may be remote from the store system and store network, that is, it is on the other side of the firewall. The financial services system 120 may fulfill the services offered on the money services device. The financial services system may be the vendor that provides the service or an intermediary. In an exemplary embodiment, the financial services system may communicate with various vendors 122-124 that fulfill the selected service.

Multiprotocol label switching (MPLS) may be used for transporting data between the store network and the financial services system. Use of MPLS provides scalability and allows services to be added without requiring significant changes to the money services device.

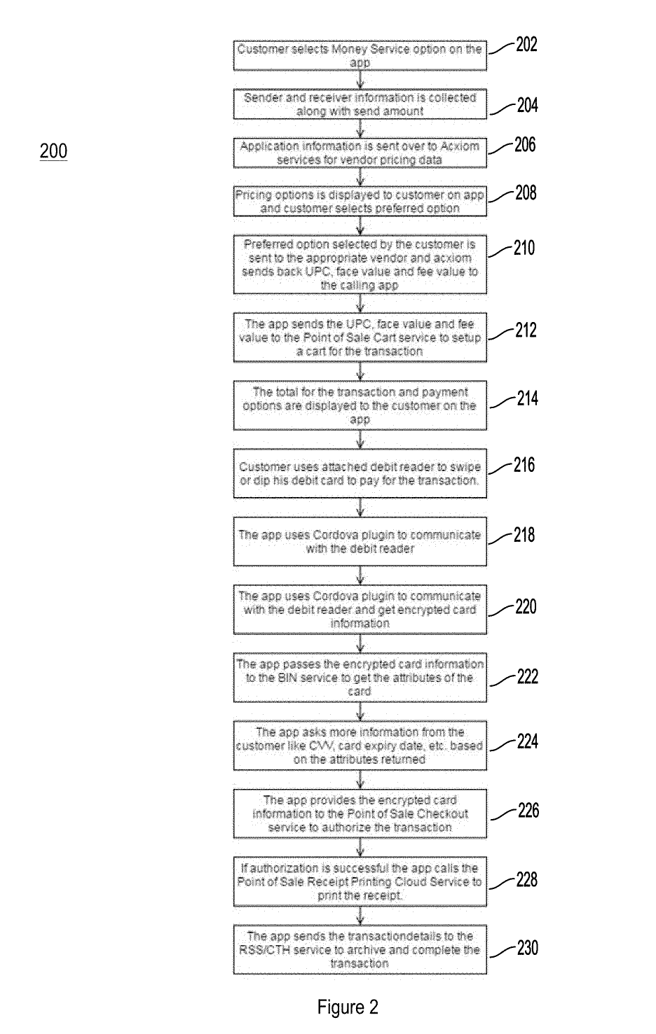

FIG. 2 illustrates a method 200 that may be performed according to an embodiment of the invention. The customer can access the available money services via the app on the money services device, 202. The app may present a number of available services to the customer. To access money services the customer selects that option on the app, for example via a menu selection or icon. The various money services options available are then presented to the customer. Typical services include “Send Money,” “Pay a Bill,” or “Cash a Check.” A log in process may also be used to associate the customer with an account or preferences.

When one of the options is selected the app prompts the customer to enter information for the transaction. For example, if “Pay a Bill,” is selected, the app prompts the customer to enter their (sender) information, the receivers' information, and an amount to be sent, 204. One or more of these fields, such as sender information, may be pre-populated based on the users profile or ID. The customer's account may be stored in a database.

The transaction information is gathered and sent to the financial services system, 206. In this embodiment, the financial services system is a gateway to a number of vendors that provide the money services. Price quotes from a number of vendors of the selected service are obtained and presented to the customer for review and selection. The app receives the selected service, which is sent to the financial services system. The financial services system communicates with the vendors, for example over the internet or other network, to obtain pricing and transaction information. The financial services system returns the transaction information to the app, which displays the vendor options to the customer, 208. For example, if the pay “Pay a Bill,” option was selected, the options may include, for example, three different vendors such as Money Send vendor, Bill Pay vendor, and Check Cashing vendor, to use to pay a bill. The quote may include the vendor, their fees and costs for bill payment.

The app receives the customer's vendor selection and that information is provided to the financial services system, 210. The financial services system interfaces with the selected vendor to continue the transaction. The vendor process the transaction and returns the final details of the transaction to the app via the financial services system. The details may include a UPC, face value and fee value for the transaction, 212. The app may use an API to call the cart module from the remote point of sale services to set up a cart for the transaction using the transaction data. The app sends the UPC, face value and fee value to the cart module. The cart is similar to a shopping cart used in e-commerce. The cart module sets up the cart and provides the final transaction details to the app, which displays these details to the customer. The UPC, description, face amount, fee amount, tax, total amount due, etc. may be displayed via the app to the customer, 214. The customer now knows the amount due for the selected service. The app also displays the available payment options to the customer. The payment options may include debit card, cash, check, e-cash, PayPal, etc.

To process the selected payment option, the app calls the peripheral module as needed. For example, if the customer elects to pay by debit card, the app calls the peripheral module for the card reader, 216. The app may also use a plug in to communicate with the card reader and obtain card information, 218. The customer swipes or dips their card into the card reader to pay for the transaction. The app receives encrypted card information and uses a BIN service for authorization of the card, 220. The BIN service provides attributes of the card, such as debit or credit card, issuer, etc. Based on the attributes, the app may request additional information from the customer such as the card expiration date, cvv code, pin code etc., 222-224. The app provides the required information to the checkout module to authorize and process the transaction, 226. The BIN service may be part of the transaction module.

If the authorization is successful, the app calls the receipt module to print the receipt, 228. The receipt module provides instruction to the printer to print the receipt. The peripherals module may monitor the printer to ensure that it is present and functioning properly.

After receipt is printed the app sends the transaction details to the RSS/CTH service to archive and complete the transaction, 230.

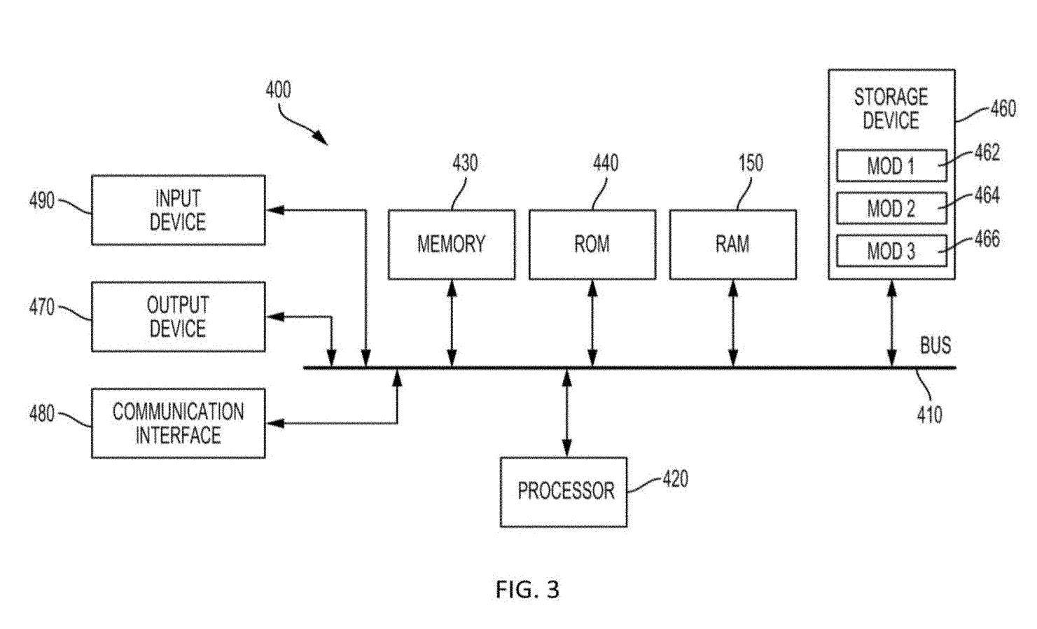

With reference to FIG. 3, an exemplary system 400 can include a processing unit (CPU or processor) 420 and a system bus 410 that couples various system components including the system memory 430 such as read only memory (ROM) 440 and random access memory (RAM) 450 to the processor 420. The system 400 can include a cache of high speed memory connected directly with, in close proximity to, or integrated as part of the processor 420. The system 400 copies data from the memory 430 and/or the storage device 460 to the cache for quick access by the processor 420. In this way, the cache provides a performance boost that avoids processor 420 delays while waiting for data. These and other modules can control or be configured to control the processor 420 to perform various actions. Other system memory 430 may be available for use as well. The memory 430 can include multiple different types of memory with different performance characteristics. It can be appreciated that the disclosure may operate on a computing device 400 with more than one processor 420 or on a group or cluster of computing devices networked together to provide greater processing capability. The processor 420 can include any general purpose processor and a hardware module or software module, such as module 1 462, module 2 464, and module 3 466 stored in storage device 460, configured to control the processor 420 as well as a special-purpose processor where software instructions are incorporated into the actual processor design. The processor 420 may essentially be a completely self-contained computing system, containing multiple cores or processors, a bus, memory controller, cache, etc. A multi-core processor may be symmetric or asymmetric.

The system bus 410 may be any of several types of bus structures including a memory bus or memory controller, a peripheral bus, and a local bus using any of a variety of bus architectures. A basic input/output (BIOS) stored in ROM 440 or the like, may provide the basic routine that helps to transfer information between elements within the computing device 400, such as during start-up. The computing device 400 further includes storage devices 460 such as a hard disk drive, a magnetic disk drive, an optical disk drive, tape drive or the like. The storage device 460 can include software modules 462, 464, 466 for controlling the processor 420. Other hardware or software modules are contemplated. The storage device 460 is connected to the system bus 410 by a drive interface. The drives and the associated computer-readable storage media provide nonvolatile storage of computer-readable instructions, data structures, program modules and other data for the computing device 400. In one aspect, a hardware module that performs a particular function includes the software component stored in a tangible computer-readable storage medium in connection with the necessary hardware components, such as the processor 420, bus 410, display 470, and so forth, to carry out the function. In another aspect, the system can use a processor and computer-readable storage medium to store instructions which, when executed by the processor, cause the processor to perform a method or other specific actions. The basic components and appropriate variations are contemplated depending on the type of device, such as whether the device 400 is a small, handheld computing device, a desktop computer, or a computer server.

Although the exemplary embodiment described herein employs the hard disk 460, other types of computer-readable media which can store data that are accessible by a computer, such as magnetic cassettes, flash memory cards, digital versatile disks, cartridges, random access memories (RAMs) 450, and read only memory (ROM) 440, may also be used in the exemplary operating environment. Tangible computer-readable storage media, computer-readable storage devices, or computer-readable memory devices, expressly exclude media such as transitory waves, energy, carrier signals, electromagnetic waves, and signals per se.

To enable user interaction with the computing device 400, an input device 490 represents any number of input mechanisms, such as a microphone for speech, a touch-sensitive screen for gesture or graphical input, keyboard, mouse, motion input, speech and so forth. An output device 470 can also be one or more of a number of output mechanisms known to those of skill in the art. In some instances, multimodal systems enable a user to provide multiple types of input to communicate with the computing device 400. The communications interface 480 generally governs and manages the user input and system output. There is no restriction on operating on any particular hardware arrangement and therefore the basic features here may easily be substituted for improved hardware or firmware arrangements as they are developed.

The various embodiments described above are provided by way of illustration only and should not be construed to limit the scope of the disclosure. Various modifications and changes may be made to the principles described herein without following the example embodiments and applications illustrated and described herein, and without departing from the spirit and scope of the disclosure.

1-9. (canceled)

10. A method, comprising:
presenting money services options to a user via an interface on a money services device;
receiving a selected option via the interface and providing information regarding the selected option to a financial services provider remote from the money services device;
receiving at the money services device vendor and pricing options for the selected option from the financial services provider and presenting the pricing options to the user via the interface;
receiving a selected vendor and pricing option via the interface and providing information regarding the selected vendor and pricing option to the financial services provider;
receiving transaction details including a fee amount for the transaction from the financial services provider and presenting the transaction details to the user;
calling a remote service from the money services device to set up a cart associated with the transaction;
receiving transaction details at the money services device from the remote service and providing the details to the user;
receiving a tender of payment from the user at the money services device and calling the remoter service to process the tender;
receiving an authorization for the transaction;
calling the remote service from the money services device to print a receipt; and
calling the remote service from the money services device to log the transaction.

11. The method of claim 10, further comprising prompting the customer to enter sender information and receiver information and the amount for the transaction and providing this information to the financial services provider.

12. The method of claim 10, receiving the details from the remote service and providing the UPC, description, face amount, fee amount and tax to the customer.

13. The method of claim 10, communicate with the debit reader to obtain the encrypted card information.

14. The method of claim 10, providing the encrypted card information to the bin service to get attributes of the card and requesting additional information based on the attributes returned.

15. The method of claim 10, wherein the additional information cvv, card expiry date

16. The method of claim 10, the app provides the encrypted card information to the point of sale checkout service to authorize the transaction.

17. The method of claim 10, if authorization is successful the app calls the point of sale receipt printing cloud service to print the receipt.

18. The method of claim 10, after receipt is printed the app sends the transaction details to the rss/cth service to archive and complete the transaction.
